(19) United States
(12) Patent Application Publication
(10) Pub. No.: US 2004/0240555 A1
(43) Pub. Date: Dec. 2, 2004

(54) Device for transmitting television pictures and device for receiving said pictures

(76) Inventors: Peter H.N. De With, Eindhoven (NL); Stephanus J.J. Nijssen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/884,156

(22) Filed: Jul. 2, 2004

Related U.S. Application Data
(63) Continuation of application No. 09/328,693, filed on Oct. 14, 1997, now Pat. No. 6,798,836.

(30) Foreign Application Priority Data
Oct. 29, 1993 (BE) 09301182

(51) Int. Cl. H04N 7/12

(52) U.S. Cl. 375/240.16; 375/240.24; 375/240.23; 375/240.12; 375/240.18

(57) ABSTRACT

Device for transmitting television pictures in the form of transform coefficients and motion vectors. The motion vectors of a sub-picture are converted (20) into a series of difference vectors and a reference vector. Said series is subsequently applied to a variable-length encoder (22) which encodes a run of zero values and a subsequent non-zero value into a code word of variable length. The variable-length encoder may be the same as the encoder which encodes the coefficients.

### FIELD OF THE INVENTION

The invention relates to a device for transmitting television pictures and to a device for receiving television pictures thus transmitted. Both devices may be combined in one apparatus, constituting a video recorder. The invention also relates to a storage medium on which television pictures are stored.

### DESCRIPTION OF THE PRIOR ART

A device for transmitting television pictures of the type described in the opening paragraph is known from European Patent Application EP 0 419 752. The known device comprises means for dividing each television picture into blocks, means for forming a motion vector for selected blocks, means for forming a reference vector and a plurality of difference vectors for the motion vectors of a plurality of contiguous blocks which constitute a sub-picture, and a variable-length encoder for encoding the difference vectors into code words of variable length.

In the known device the reference vector is constituted by the mean value of the motion vectors of the sub-picture. The reference vector is transmitted as a code word of fixed length. The difference vectors are transmitted as code words of variable length. With this, a certain extent of encoding efficiency and protection from channel errors is aimed at.

### OBJECT AND SUMMARY OF THE INVENTION

It is an object of the invention to further improve the encoding efficiency of the device.

According to the invention the device is therefore characterized in that the motion vectors of a sub-picture are applied to the variable-length encoder in the form of a series which successively comprises the difference vectors and the reference vector, the variable-length encoder being of a type which allocates a code word of variable length to a series of zero values and a subsequent non-zero value.

The invention is based on the recognition that moving objects in a picture are generally larger than one block. This means that the blocks of a sub-picture generally comprise the same quantity of motion. The difference vectors then have a value of zero, whereas the reference vector is often unequal to zero. By presenting such a series of zero values and a subsequent non-zero value to the variable-length encoder, it will often compress the motion information of a sub-picture to one code word only.

The reference vector is preferably constituted by the motion vector of a selected block of the sub-picture. It is then no longer necessary to transmit a difference vector for this block so that the encoding efficiency further increases. The difference vectors are preferably formed from the motion vectors of contiguous blocks. The difference in motion of a block with a contiguous block is smaller than with a more remote reference block because contiguous blocks generally have a larger extent of corresponding motion. The difference vectors thus more frequently have the value of zero and are then encoded more efficiently.

In a preferred embodiment of the device the variable-length encoder is constituted by the variable-length encoder for encoding coefficients which are obtained from picture transform of a block. A separate variable-length encoder can thus be dispensed with. Moreover, it has been found that the series of applied motion vectors statistically corresponds satisfactorily to the distribution of coefficients within a block in which series of zero coefficients are often followed by a non-zero coefficient. The encoding efficiency is thus even further improved.

A corresponding device for receiving television pictures is characterized in that it comprises a variable-length decoder of a type which decodes a code word of variable length into a series of zero values and a subsequent non-zero value. In a preferred embodiment the variable-length decoder is constituted by the variable-length decoder which is already present for decoding the coefficients.

### BRIEF DESCRIPTION OF THE FIGURES

FIG. 1 shows diagrammatically a transmission system comprising a device for transmitting and receiving television pictures according to the invention.

FIG. 2 shows a possible choice of a sub-picture to explain the invention.

FIG. 3 shows a possible embodiment of a series former shown in FIG. 1.

FIG. 4 shows a possible embodiment of a converter shown in FIG. 1.

FIGS. 5A and 5B show some sub-pictures to explain the operation of the series former shown in FIG. 3.

FIG. 6 shows a further embodiment of a transmission system comprising a device for transmitting and receiving television pictures.

### DESCRIPTION OF EMBODIMENTS

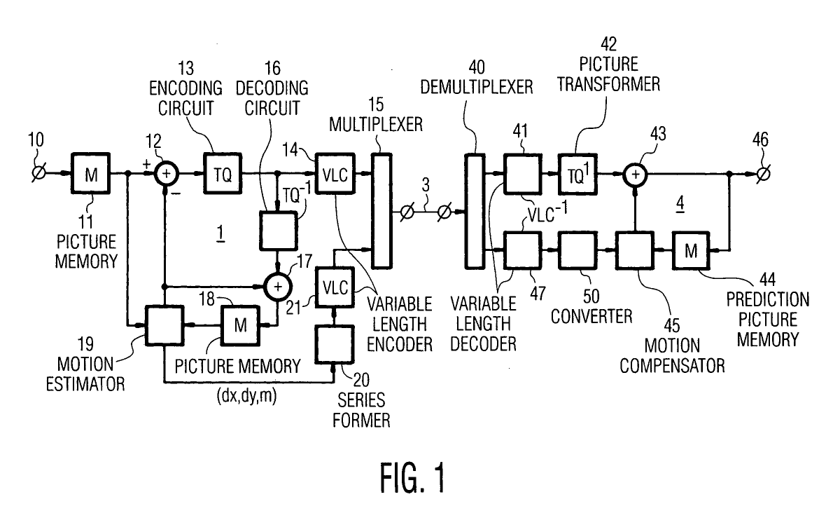

FIG. 1 shows diagrammatically a television transmission system comprising a device according to the invention. The system comprises a device 1 for transmitting television pictures (hereinafter referred to as transmitter), a transmission channel 3 and a device 4 for receiving the transmitted television pictures (hereinafter referred to as receiver). In practice, the transmission system shown may be a video recorder. In that case transmission channel 3 is constituted as a storage medium.

An input 10 of transmitter 1 receives a digital video signal. The received pictures are stored in a first picture memory 11 and applied in blocks from this memory to a subtracter circuit 12. In the subtracter circuit a motion-compensated prediction picture is subtracted from the current picture. The difference picture is encoded in an encoding circuit 13 which performs, for example a Discrete Cosine Transform and quantizes the coefficients obtained therefrom. The quantized coefficients are subjected to variable-length encoding in a variable-length encoder 14. The code words thus obtained are transmitted via a multiplexer 15. A prediction loop in the transmitter comprises a decoding circuit 16 which performs the inverse operations of encoding circuit 13. The difference picture is thereby regained and added in an adder circuit 17 to the current prediction picture in order to form the next prediction picture in a second picture memory 18. A motion estimator 19 receives the current picture from picture memory 11 and the prediction picture from picture memory 18 and supplies the motion-compensated prediction picture to the subtracter circuit 12. Moreover, the motion estimator supplies motion vectors (dx,dy) for transmission to a receiver. The transmitter hitherto described is generally known and described, for example in “Digitale Bildcodierung, Bewegungskompensierte Interframe-DPCM”, FKT 6/1992, pp. 416-424.

In accordance with the invention, the transmitter further comprises a series former 20 to which the motion vectors (dx,dy) are applied and which will be further described. The series former forms a series of difference vectors and a reference vector for a plurality of blocks of the television picture and applies these vectors to a second variable-length encoder 21. The two variable-length encoders 14 and 21 are coupled to the multiplexer 15 in order that this multiplexer applies both the code words which are representative of coefficients and the code words which are representative of motion vectors to transmission channel 3.

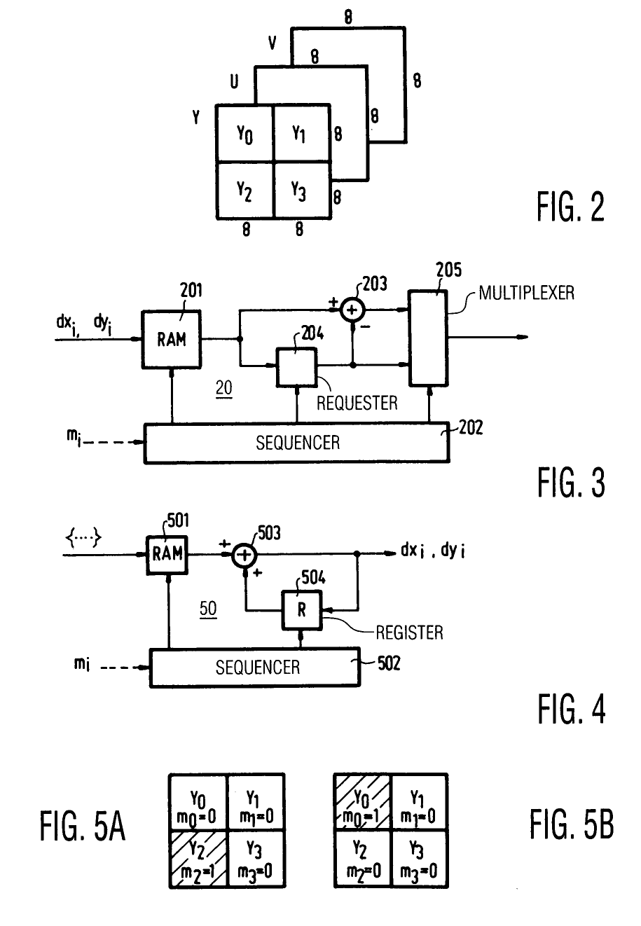

In practice, the picture transformer 13 and motion estimator 19 operate on picture blocks of, for example 8*8 pixels. The picture transform is separately realised for the luminance Y and the chrominance U and V of the television signal. If the sample frequency of the chrominance signals in the horizontal and vertical direction is half the sample frequency of the luminance signal, one chrominance block U and one chrominance block V is obtained for four luminance blocks Y. This is customarily referred to as a macro block. Such a macro block forms a sub-picture and is shown symbolically in FIG. 2. Other manners of forming a sub-picture from a plurality of contiguous blocks are, however, alternatively possible.

The motion estimation is performed for each of the luminance blocks. A separate motion estimation for the chrominance blocks may be refrained from because it may be assumed that they are subject to the same motion as the Y blocks. For each macro block Y₀, Y₁, Y₂, Y₃ (see FIG. 2) a motion vector (dxᵢ,dyᵢ) is formed by the motion estimator 19 (see FIG. 1), in which dxᵢ and dyᵢ (i=0 . . . 3) represent the horizontal and vertical shift of a block with respect to the corresponding block in the prediction picture.

FIG. 3 shows a possible embodiment of the series former 20 shown in FIG. 1. It comprises a RAM 201 in which the motion vectors (dxᵢ,dyᵢ) are stored at predetermined locations by the motion estimator. The RAM is read under the control of a sequencer 202. The values read are applied to a first input of a subtracter circuit 203. Moreover the values read can be stored in a register 204 in response to a clock signal generated by the sequencer. The second input of the subtracter circuit 203 is coupled to the output of register 204. Again under the control of the sequencer, either the output of the subtracter circuit or the output of the register is selected via a multiplexer 205 for supply to the variable-length encoder 21 (see FIG. 1).

The operation of the series former 20 is further based on instructions stored in the sequencer. In a first embodiment the sequencer carries out the following instructions:

1. store dx₂ in the register

2. apply dx₃ to the subtracter circuit

3. select the subtracter circuit, i.e. dx₃−dx₂

4. store dx₀ in the register

5. apply dx₂ to the subtracter circuit

6. select the subtracter circuit, i.e. dx₂−dx₀

7. apply dx₁ to the subtracter circuit

8. select the subtracter circuit, i.e. dx₁−dx₀

9. select the register, i.e. dx₀

In this way the series former forms a series of numbers:

{dx₃−dx₂, dx₂−dx₀, dx₁−dx₀, dx₀},

In other words, a series of difference vectors followed by a reference vector which is formed by dx₀ in this case. In a corresponding manner a series of numbers

{dy₃−dy₂, dy₂−dy₀, dy₁−dy₀, dy₀},

is subsequently formed for the vertical component of the motion vectors. In this second series of numbers, the reference vector is formed by dy₀.

The two series of numbers are applied to the variable-length encoder 21 (see FIG. 1). This encoder is of a type which allocates a code word of variable length to a series of zero values and a subsequent non-zero value. A favourable embodiment of such an encoder is described extensively in European Patent Application EP 0 260 748. If the difference vectors have the value of zero, the encoder supplies only one code word for each series of numbers. In practice, this frequently occurs so that the motion vectors of the sub-picture are encoded efficiently.

A second embodiment of the sequencer is adapted to generate the following series of numbers:

{dy₃−dy₂, dy₂−dy₀, dy₁−dy₀, dx₃−dx₂, dx₂−dx₀, dx₁−dx₀, dy₀, dx₀}

This series starts with the difference vectors in the vertical direction. These difference vectors often have the value of zero because the picture (particularly a 16:9 picture) is smaller in the vertical direction than in the horizontal direction. The relatively long series of numbers therefore often starts with many zero values. This contributes to the efficiency of the variable-length encoding. Moreover, much motion is caused by horizontal panning of the television camera. In that case the long series of numbers yields only one code word.

As is apparent from the series of numbers, the difference is determined by means of the motion vector of the adjoining block Y₂ for block Y₃ in both embodiments. This is more favourable than subtraction from the reference vector (as is done in the known device) because the reference vector is the motion vector of a block which is further remote (here Y₀) whose motion is less frequently equal. Determination of the difference between the motion vector of block Y₃ and that of block Y₁ would also be a suitable choice. It is even sensible to make a different choice for the horizontal component of the motion vector than for the vertical component.

A corresponding device for receiving the television pictures will now be described. In FIG. 1, the receiver 4 comprises a demultiplexer 40 by means of which the channel bit stream is split into encoded coefficients and encoded motion vectors. The receiver further comprises in known manner a variable-length decoder 41 for decoding the coefficients, an inverse quantizer and picture transformer 42, an adder circuit 43 for reconstructing the received picture, a prediction picture memory 44 and a motion compensator 45. The reconstructed picture is applied to an output 46. Variable-length decoder 41 performs the inverse operation of encoder 14.

In accordance with the invention, the encoded motion vectors are applied to a second variable-length decoder 47. This decoder performs the inverse operation of encoder 21 so that the series of numbers are obtained which are representative of the motion vectors. The series of numbers are subsequently converted by a converter 50 into the individual motion vectors (dx,dy) by means of which the motion compensator 45 reconstructs the blocks of the prediction picture.

FIG. 4 shows a possible embodiment of the converter 50 shown in FIG. 1. It comprises a RAM 501 in which the decoded series of numbers is stored upon reception. The RAM is read under the control of a sequencer 502. The values which have been read are applied to a first input of an adder circuit 503. Its output is fed back via a register 504 to the second input of the adder circuit. The register receives clock and reset signals from the sequencer 502.

The operation of the converter 50 is further based on instructions which are stored in the sequencer. The converter performs the inverse operations of series former 20 in the transmitter (see FIG. 3). To this end, the sequencer carries out the following instructions in a first embodiment:

1. reset the register

2. read dx₀ from RAM, Output signal is dx₀

3. clock output signal in the register

4. read dx₁−dx₀ from RAM, output signal is dx₁

5. read dx₂−dx₀ from RAM, output signal is dx₂

6. clock output signal in the register

7. read dx₃−dx₂ from RAM, output signal is dx₃

In this way the horizontal components dxᵢ of the motion vectors of the sub-picture are regained. In a corresponding manner, the vertical components dy₁ are subsequently obtained. A second embodiment of the sequencer (for regaining the motion vectors from the previously described “long” series of numbers) can be derived by those skilled in the art from the foregoing explanation.

In some cases the motion within a picture is distributed in such a way that it is more favourable to subject given blocks to intraframe coding. In this way the situation may arise that one or more blocks of a sub-picture are transmitted in themselves (i.e. without motion vectors), whereas other blocks of the same sub-picture are subjected to motion compensated interframe coding. Such a strategy is used, inter alia in the known MPEG standard. A mode bit is generated by the motion estimator 19 (see FIG. 1) and transmitted so as to indicate the encoding mode used for each block.

In a corresponding embodiment of the series former 20 (see FIG. 3) the sequencer 202 is adapted to produce the series of numbers in dependence upon the encoding mode. As is shown in a broken line in FIG. 3, the sequencer now receives the mode bits mi (i=0 . . . 3) which correspond to the blocks Y₀ . . . Y₃. By means of the value 1, the mode bit indicates that a block is subjected to intraframe coding and the value 0 indicates that it is subjected to interframe coding. To explain the operation of the sequencer, FIGS. 5A and 5B show two examples of macro blocks, one block of which is subjected to intraframe coding. In FIG. 5A, the shaded block Y₂ represents an intraframe-coded block. In this case the sequencer forms the series of numbers:

{dx₃−dx₁, dx₁−dx₀, dx₀} and {dy₃−dy₁, dy₁−dy₀, dy₀}

In FIG. 5B, Y₀ is the intraframe-coded block. Since no motion vectors are generated for this block, the motion vectors of the next interframe block (here Y₁) form the reference vector. The sequencer now forms the series of numbers:

{dx₃−dx₂, dx₃−dx₁, dx₁} and {dy₃−dy₂, dy₃−dy₁, dy₁}

The sequencer 502 (see FIG. 4) in the receiver performs the inverse operations for regaining the motion vectors. Embodiments of the two sequencers can be simply derived by those skilled in the art from the previous explanation.

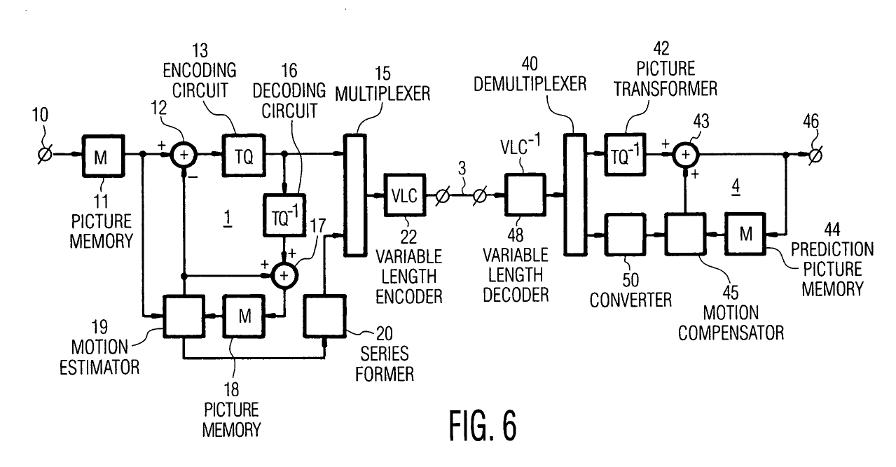

FIG. 6 shows a further embodiment of a transmission system comprising a transmitter and a receiver according to the invention. Identical reference numerals refer to the same elements as in FIG. 1. The system is distinguished from the system shown in FIG. 1 in that the transmitter 1 comprises a variable-length encoder 22 for encoding coefficients as well as motion vectors. To this end, the multiplexer 15 is arranged in front of said encoder. The variable-length encoder is of the type which allocates a code word of variable length to a series of zero values and a subsequent non-zero value. In a corresponding manner, the receiver 4 comprises one variable-length decoder 48 and, arranged behind it, the demultiplexer 40 for splitting coefficients and motion vectors. The embodiment shown in FIG. 6 is both economical and efficient. On the one hand, a variable-length (de)coder is saved in each transmitter and receiver. On the other hand, it has been found that the series of numbers representing motion vectors are statistically satisfactorily suitable for the series of coefficients to which relatively short code words are allocated.

The devices according to the invention may also be used in encoding systems in which only one motion vector per macro block is generated. This is, for example the case in the MPEG standard. In this case a sub-picture can be formed across a plurality of contiguous macro blocks. The series of numbers for supply to the variable-length encoder is then formed in the manner already described from the corresponding plurality of motion vectors.

It should finally be noted that the same reference vector whose value is derived from the pan and tilt movements of the television camera supplying the television pictures can be transmitted for the entire picture.

1-10. (Cancelled).

11. A method for coding a video signal including pictures, comprising the steps of:
dividing each picture into blocks;
forming motion vectors for the blocks;
forming a reference vector and a plurality of difference vectors from the motion vectors of a plurality of contiguous blocks that form a sub-picture, the reference vector being the motion vector of any one of the plurality of contiguous blocks that form a sub-picture.

12. The method of claim 11, further comprising subjecting each of the blocks to either an intraframe encoding mode or an interframe encoding mode.

13. The method of claim 11, further comprising transforming each of the blocks into coefficients.

14. A method for coding a video signal including pictures, comprising the steps of:
dividing each picture into blocks;
forming a motion vector for each of the blocks;
forming a difference vector for each of the blocks, the difference vector being a difference between the motion vector of each of the blocks and a reference vector, the reference vector being the motion vector of any one of a plurality of contiguous blocks that form a sub-picture.

15. The method of claim 14, further comprising transforming each of the blocks into coefficients.

16. A method for decoding a video signal including coefficients, a reference vector and a plurality of difference vectors associated with each plurality of contiguous blocks that form a sub-picture, the method comprising the steps of:
forming motion vectors from the reference vector and a plurality of difference vectors associated with each plurality of contiguous blocks that form a sub-picture, the reference vector being the motion vector of any one of the plurality of contiguous blocks that form a sub-picture.

17. The method of claim 16, further comprising transforming the coefficients into blocks.

18. A method for decoding a video signal including coefficients and a plurality of difference vectors, each of the difference vector being a difference between the motion vector of each of the blocks and a reference vector, the method comprising the steps of:
forming motion vectors from the plurality of difference vectors, the reference vector being the motion vector of any one of a plurality of contiguous blocks that form a sub-picture.

19. The method of claim 18, further comprising transforming the coefficients into blocks.
